(19) United States
(12) Patent Application Publication
(10) Pub. No.: US 2025/0151807 A1
(43) Pub. Date: May 15, 2025

(54) AEROSOL GENERATING DEVICE AND METHOD OF OPERATING THE SAME

(71) Applicant: KT&G CORPORATION, Daejeon (KR)

(72) Inventors: Yonghwan KIM, Anyang-si Gyeonggi-do (KR); Dongsung KIM, Seoul (KR); Hunil LIM, Seoul (KR); Seoksu JANG, Daejeon (KR)

(73) Assignee: KT&G CORPORATION, Daejeon (KR)

(21) Appl. No.: 18/715,026

(22) PCT Filed: Dec. 6, 2022
(86) PCT No.: PCT/KR2022/019743

§ 371 Date: May 30, 2024

(30) Foreign Application Priority Data
Dec. 7, 2021 (KR) 10-2021-0174257

(51) Int. Cl. A24F 40/53; A24F 40/20; A24F 40/60

(52) U.S. Cl. CPC A24F 40/53; A24F 40/20; A24F 40/60

(57) ABSTRACT

An aerosol generating device and a method of operating the same are provided. The aerosol generating device includes: a housing having an insertion space into which a stick is inserted; a battery; a display; and a controller, wherein the controller is configured to: calculate, based on a remaining power capacity stored in the battery being less than a predetermined power capacity, a number of sticks corresponding to the remaining power capacity; and output the calculated number of sticks through the display.

### TECHNICAL FIELD

The present disclosure relates to an aerosol generating device and a method of operating the same.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another objective of the present disclosure to provide an aerosol generating device that can intuitively switch a screen displayed on a display, and a method of operating the same.

It is yet another objective of the present disclosure to provide an aerosol generating device that can provide a user with information regarding the remaining power capacity of a battery in various ways, and a method of operating the same.

It is yet another objective of the present disclosure to provide an aerosol generating device that can inform a user of the number of sticks available for use based on the remaining power capacity of a battery, and a method of operating the same.

It is yet another objective of the present disclosure to provide an aerosol generating device that can variously change settings related to power consumption to allow a user to consume a desired number of sticks, and a method of operating the same.

### Solution to Problem

According to one aspect of the subject matter described in this application, an aerosol generating device includes: a housing having an insertion space into which a stick is inserted; a battery; a display; and a controller, wherein the controller is configured to: calculate, based on a remaining power capacity stored in the battery being less than a predetermined power capacity, a number of sticks corresponding to the remaining power capacity; and output the calculated number of sticks through the display.

According to another aspect of the subject matter described in this application, a method of operating an aerosol generating device is provided. The method may include: calculating, based on a remaining power capacity stored in a battery of the aerosol generating device being less than a predetermined power capacity, a number of sticks corresponding to the remaining power capacity; and outputting, through a display of the aerosol generating device, the calculated number of sticks.

### Advantageous Effects of Invention

According to at least one of the embodiments of the present disclosure, a screen displayed on a display may be intuitively switched.

According to at least one of the embodiments of the present disclosure, information regarding the remaining power capacity of a battery may be provided to a user in various ways.

According to at least one of the embodiments of the present disclosure, the number of sticks available for use based on the remaining power capacity of a battery may be informed to a user.

According to at least one of the embodiments of the present disclosure, settings related to power consumption may be variously changed so as to allow a user to consume a desired number of sticks.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2 to 4 are views for explaining an aerosol-generating device according to embodiments of the present disclosure;

FIGS. 5 and 6 are views for explaining a stick according to embodiments of the present disclosure;

FIG. 7 is a flowchart showing a method of operating an aerosol-generating device according to an embodiment of the present disclosure; and

FIGS. 8A and 14D are views for explaining operation of an aerosol-generating device according to an embodiment of the present disclosure.

### BEST MODE FOR CARRYING OUT THE INVENTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description. The “module” and “unit” are do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

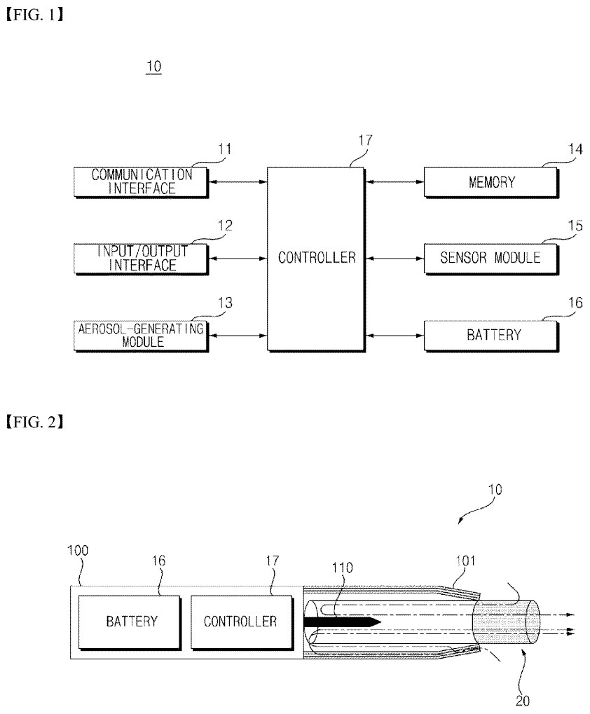

FIG. 1 is a block diagram of an aerosol-generating device according to an embodiment of the present disclosure.

Referring to FIG. 1, an aerosol-generating device 10 may include a communication interface 11, an input/output interface 12, an aerosol-generating module 13, a memory 14, a sensor module 15, a battery 16, and/or a controller 17.

In one embodiment, the aerosol-generating device 10 may be composed only of a main body. In this case, components included in the aerosol-generating device 10 may be located in the main body. In another embodiment, the aerosol-generating device 10 may be composed of a cartridge, which contains an aerosol-generating substance, and a main body. In this case, the components included in the aerosol-generating device 10 may be located in at least one of the main body or the cartridge.

The communication interface 11 may include at least one communication module for communication with an external device and/or a network. For example, the communication interface 11 may include a communication module for wired communication, such as a Universal Serial Bus (USB). For example, the communication interface 11 may include a communication module for wireless communication, such as Wireless Fidelity (Wi-Fi), Bluetooth, Bluetooth Low Energy (BLE), ZigBee, or nearfield communication (NFC).

The input/output device 12 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output device 12 may transmit data corresponding to a command input by the user through the input device to another component (or other components) of the aerosol-generating device 100. The input/output device 12 may output information corresponding to data received from another component (or other components) of the aerosol-generating device 10 through the output device.

The aerosol-generating module 13 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 13 may include at least one heater (not shown).

The aerosol-generating module 13 may include an electro-resistive heater. For example, the electro-resistive heater may include at least one electrically conductive track. The electro-resistive heater may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 13 may include a heater that uses an induction-heating method. For example, the induction heater may include an electrically conductive coil. The induction heater may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss. In addition, the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 13 may generate ultrasonic vibrations to thereby generate an aerosol from the aerosol-generating substance.

The aerosol-generating device 10 may be referred to as a cartomizer, an atomizer, or a vaporizer.

The memory 14 may store programs for processing and controlling each signal in the controller 17. The memory 14 may store processed data and data to be processed.

For example, the memory 14 may store applications designed for the purpose of performing various tasks that can be processed by the controller 17. The memory 14 may selectively provide some of the stored applications in response to the request from the controller 17.

For example, the memory 14 may store data on the operation time of the aerosol-generating device 100, the maximum number of puffs, the current number of puffs, the number of uses of battery 16, at least one temperature profile, the user's inhalation pattern, and data about charging/discharging. Here, “puff” means inhalation by the user. “inhalation” means the user's act of taking air or other substances into the user's oral cavity, nasal cavity, or lungs through the user's mouth or nose.

The memory 14 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 15 may include at least one sensor.

For example, the sensor module 15 may include a sensor for sensing a puff (hereinafter referred to as a “puff sensor”). In this case, the puff sensor may be implemented as a proximity sensor such as an IR sensor, a pressure sensor, a gyro sensor, an acceleration sensor, a magnetic field sensor, or the like.

For example, the sensor module 15 may include a sensor for sensing a puff (hereinafter referred to as a “puff sensor”). In this case, the puff sensor may be implemented by a pressure sensor, a gyro sensor, an acceleration sensor, a magnetic field sensor, or the like.

For example, the sensor module 15 may include a sensor for sensing the temperature of the heater included in the aerosol-generating module 13 and the temperature of the aerosol-generating substance (hereinafter referred to as a “temperature sensor”). In this case, the heater included in the aerosol-generating module 13 may also serve as the temperature sensor. For example, the electro-resistive material of the heater may be a material having a predetermined temperature coefficient of resistance. The sensor module 15 may measure the resistance of the heater, which varies according to the temperature, to thereby sense the temperature of the heater.

For example, in the case in which the main body of the aerosol-generating device 10 is formed to allow a stick to be inserted thereinto, the sensor module 15 may include a sensor for sensing insertion of the stick (hereinafter referred to as a “stick detection sensor”).

For example, in the case in which the aerosol-generating device 10 includes a cartridge, the sensor module 15 may include a sensor for sensing mounting/demounting of the cartridge and the position of the cartridge (hereinafter referred to as a “cartridge detection sensor”).

In this case, the stick detection sensor and/or the cartridge detection sensor may be implemented as an inductance-based sensor, a capacitive sensor, a resistance sensor, or a Hall sensor (or Hall IC) using a Hall effect.

For example, the sensor module 15 may include a voltage sensor for sensing a voltage applied to a component (e.g. the battery 16) provided in the aerosol-generating device 10 and/or a current sensor for sensing a current.

The battery 16 may supply electric power used for the operation of the aerosol-generating device 10 under the control of the controller 17. The battery 16 may supply electric power to other components provided in the aerosol-generating device 100. For example, the battery 16 may supply electric power to the communication module included in the communication interface 11, the output device included in the input/output interface 12, and the heater included in the aerosol-generating module 13.

The battery 16 may be a rechargeable battery or a disposable battery. For example, the battery 16 may be a lithium-ion (Li-ion) battery or a lithium polymer (Li-polymer) battery. However, the present disclosure is not limited thereto. For example, when the battery 16 is rechargeable, the charging rate (C-rate) of the battery 16 may be 10 C, and the discharging rate (C-rate) thereof may be 10 C to 20 C. However, the present disclosure is not limited thereto. Also, for stable use, the battery 16 may be manufactured such that 80% or more of the total capacity may be ensured even when charging/discharging is performed 2000 times.

The aerosol-generating device 10 may further include a protection circuit module (PCM) (not shown), which is a circuit for protecting the battery 16. The protection circuit module (PCM) may be disposed adjacent to the upper surface of the battery 16. For example, in order to prevent overcharging and overdischarging of the battery 16, the protection circuit module (PCM) may cut off the electrical path to the battery 16 when a short circuit occurs in a circuit connected to the battery 16, when an overvoltage is applied to the battery 16, or when an overcurrent flows through the battery 16.

The aerosol-generating device 10 may further include a charging terminal to which electric power supplied from the outside is input. For example, the charging terminal may be formed at one side of the main body of the aerosol-generating device 100. The aerosol-generating device 10 may charge the battery 16 using electric power supplied through the charging terminal. In this case, the charging terminal may be configured as a wired terminal for USB communication, a pogo pin, or the like.

The aerosol-generating device 10 may further include a power terminal (not shown) to which electric power supplied from the outside is input. For example, a power line may be connected to the power terminal, which is disposed at one side of the main body of the aerosol-generating device 100. The aerosol-generating device 10 may use the electric power supplied through the power line connected to the power terminal to charge the battery 16. In this case, the power terminal may be a wired terminal for USB communication.

The aerosol-generating device 10 may wirelessly receive electric power supplied from the outside through the communication interface 11. For example, the aerosol-generating device 10 may wirelessly receive electric power using an antenna included in the communication module for wireless communication. The aerosol-generating device 10 may charge the battery 16 using the wirelessly supplied electric power.

The controller 17 may control the overall operation of the aerosol-generating device 100. The controller 17 may be connected to each of the components provided in the aerosol-generating device 100. The controller 17 may transmit and/or receive a signal to and/or from each of the components, thereby controlling the overall operation of each of the components.

The controller 17 may include at least one processor. The controller 17 may control the overall operation of the aerosol-generating device 10 using the processor included therein. Here, the processor may be a general processor such as a central processing unit (CPU). Of course, the processor may be a dedicated device such as an application-specific integrated circuit (ASIC), or may be any of other hardware-based processors.

The controller 17 may perform any one of a plurality of functions of the aerosol-generating device 100. For example, the controller 17 may perform any one of a plurality of functions of the aerosol-generating device 10 (e.g. a preheating function, a heating function, a charging function, and a cleaning function) according to the state of each of the components provided in the aerosol-generating device 10 and the user's command received through the input/output interface 12.

The controller 17 may control the operation of each of the components provided in the aerosol-generating device 10 based on data stored in the memory 14. For example, the controller 17 may control the supply of a predetermined amount of electric power from the battery 16 to the aerosol-generating module 13 for a predetermined time based on the data on the temperature profile, the user's inhalation pattern, which is stored in the memory 14.

The controller 17 may determine the occurrence or non-occurrence of a puff using the puff sensor included in the sensor module 15. For example, the controller 17 may check a temperature change, a flow change, a pressure change, and a voltage change in the aerosol-generating device 10 based on the values sensed by the puff sensor. The controller 17 may determine the occurrence or non-occurrence of a puff based on the value sensed by the puff sensor.

The controller 17 may control the operation of each of the components provided in the aerosol-generating device 10 according to the occurrence or non-occurrence of a puff and/or the number of puffs. For example, the controller 17 may perform control such that the temperature of the heater is changed or maintained based on the temperature profile stored in the memory 14.

The controller 17 may perform control such that the supply of electric power to the heater is interrupted according to a predetermined condition. For example, the controller 17 may perform control such that the supply of electric power to the heater is interrupted when the stick is removed, when the cartridge is demounted, when the number of puffs reaches the predetermined maximum number of puffs, when a puff is not sensed during a predetermined period of time or longer, or when the remaining capacity of the battery 16 is less than a predetermined value.

The controller 17 may calculate the remaining capacity with respect to the full charge capacity of the battery 16. For example, the controller 17 may calculate the remaining capacity of the battery 16 based on the values sensed by the voltage sensor and/or the current sensor included in the sensor module 15.

The controller 17 may perform control such that electric power is supplied to the heater using at least one of a pulse width modulation (PWM) method or a proportional-integral-differential (PID) method.

For example, the controller 17 may perform control such that a current pulse having a predetermined frequency and a predetermined duty ratio is supplied to the heater using the PWM method. In this case, the controller 17 may control the amount of electric power supplied to the heater by adjusting the frequency and the duty ratio of the current pulse.

For example, the controller 17 may determine a target temperature to be controlled based on the temperature profile. In this case, the controller 17 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

Meanwhile, the controller 17 may perform control such that electric power is supplied to the heater according to a predetermined condition. For example, when a cleaning function for cleaning the space into which the stick is inserted is selected in response to a command input by the user through the input/output interface 12, the controller 17 may perform control such that a predetermined amount of electric power is supplied to the heater.

FIGS. 2 to 4 are views for explaining an aerosol-generating device according to embodiments of the present disclosure.

According to various embodiments of the present disclosure, the aerosol-generating device 10 may include a main body 100 and/or a cartridge 200.

Referring to FIG. 2, the aerosol-generating device 10 according to an embodiment may include a main body 100, which is formed such that a stick 20 can be inserted into the inner space formed by a housing 101.

The stick 20 may be similar to a general combustive cigarette. For example, the stick 20 may be divided into a first portion including an aerosol generating material and a second portion including a filter and the like. Alternatively, an aerosol generating material may be included in the second portion of the stick 20. For example, a flavoring substance made in the form of granules or capsules may be inserted into the second portion.

The entire first portion is inserted into the insertion space of the aerosol-generating device 10, and the second portion may be exposed to the outside. Alternatively, only a portion of the first portion may be inserted into the insertion space of the aerosol-generating device 10, or a portion of the first portion and the second portion may be inserted. In this case, the aerosol may be generated by passing external air through the first portion, and the generated aerosol may be delivered to the user's mouth through the second portion.

The main body 100 may be structured such that external air is introduced into the main body 100 in the state in which the stick 20 is inserted thereinto. In this case, the external air introduced into the main body 100 may flow into the mouth of the user via the stick 20.

The heater may be disposed in the main body 100 at a position corresponding to the position at which the stick 20 is inserted into the main body 100. Although it is illustrated in the drawings that the heater is an electrically conductive heater 110 including a needle-shaped electrically conductive track, the present disclosure is not limited thereto.

The heater may heat the interior and/or exterior of the stick 20 using the electric power supplied from the battery 16. An aerosol may be generated from the heated stick 20. At this time, the user may hold one end of the stick 20 in the mouth to inhale the aerosol containing a tobacco material.

Meanwhile, the controller 17 may perform control such that electric power is supplied to the heater in the state in which the stick 20 is not inserted into the main body according to a predetermined condition. For example, when a cleaning function for cleaning the space into which the stick 20 is inserted is selected in response to a command input by the user through the input/output interface 12, the controller 17 may perform control such that a predetermined amount of electric power is supplied to the heater.

The controller 17 may monitor the number of puffs based on the value sensed by the puff sensor from the point in time at which the stick 20 was inserted into the main body.

When the stick 20 is removed from the main body, the controller 17 may initialize the current number of puffs stored in the memory 14.

Referring to FIG. 3, the aerosol-generating device 10 according to an embodiment may include a main body 100 and a cartridge 200. The main body 100 may support the cartridge 200, and the cartridge 200 may contain an aerosol-generating substance.

According to one embodiment, the cartridge 200 may be configured so as to be detachably mounted to the main body 100. According to another embodiment, the cartridge 200 may be integrally configured with the main body 100. For example, the cartridge 200 may be mounted to the main body 100 in a manner such that at least a portion of the cartridge 200 is inserted into the insertion space formed by a housing 101 of the main body 100.

The main body 100 may be formed to have a structure in which external air can be introduced into the main body 100 in the state in which the cartridge 200 is inserted thereinto. Here, the external air introduced into the main body 100 may flow into the user's mouth via the cartridge 200.

The controller 17 may determine whether the cartridge 200 is in a mounted state or a detached state using a cartridge detection sensor included in the sensor module 15. For example, the cartridge detection sensor may transmit a pulse current through a first terminal connected with the cartridge 200. In this case, the controller 17 may determine whether the cartridge 200 is in a connected state, based on whether the pulse current is received through a second terminal.

The cartridge 200 may include a heater 210 configured to heat the aerosol-generating substance and/or a reservoir 220 configured to contain the aerosol-generating substance. For example, a liquid delivery element impregnated with (containing) the aerosol-generating substance may be disposed inside the reservoir 220. The electrically conductive track of the heater 210 may be formed in a structure that is wound around the liquid delivery element. In this case, when the liquid delivery element is heated by the heater 210, an aerosol may be generated. Here, the liquid delivery element may include a wick made of, for example, cotton fiber, ceramic fiber, glass fiber, or porous ceramic.

The cartridge 200 may include an insertion space 230 configured to allow the stick 20 to be inserted. For example, the cartridge 200 may include the insertion space formed by an inner wall extending in a circumferential direction along a direction in which the stick 20 is inserted. In this case, the insertion space may be formed by opening the inner side of the inner wall up and down. The stick 20 may be inserted into the insertion space formed by the inner wall.

The insertion space into which the stick 20 is inserted may be formed in a shape corresponding to the shape of a portion of the stick 20 inserted into the insertion space. For example, when the stick 20 is formed in a cylindrical shape, the insertion space may be formed in a cylindrical shape.

When the stick 20 is inserted into the insertion space, the outer surface of the stick 20 may be surrounded by the inner wall and contact the inner wall.

A portion of the stick 20 may be inserted into the insertion space, the remaining portion of the stick 20 may be exposed to the outside.

The user may inhale the aerosol while biting one end of the stick 20 with the mouth. The aerosol generated by the heater 210 may pass through the stick 20 and be delivered to the user's mouth. At this time, while the aerosol passes through the stick 20, the material contained in the stick 20 may be added to the aerosol. The material-infused aerosol may be inhaled into the user's oral cavity through the one end of the stick 20.

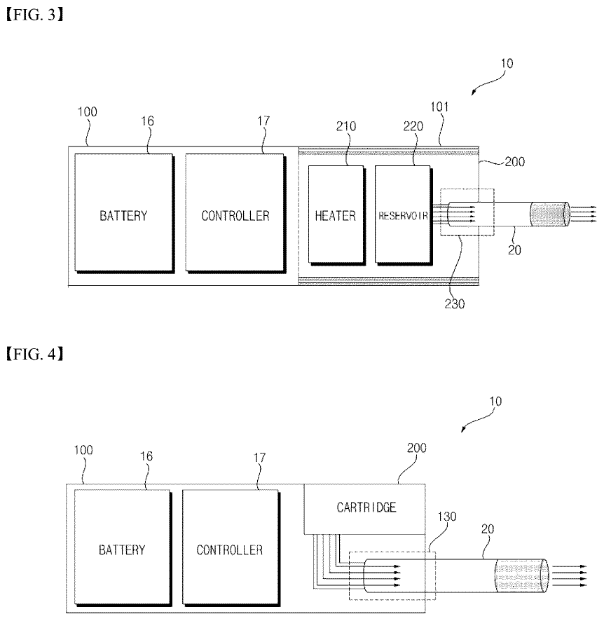

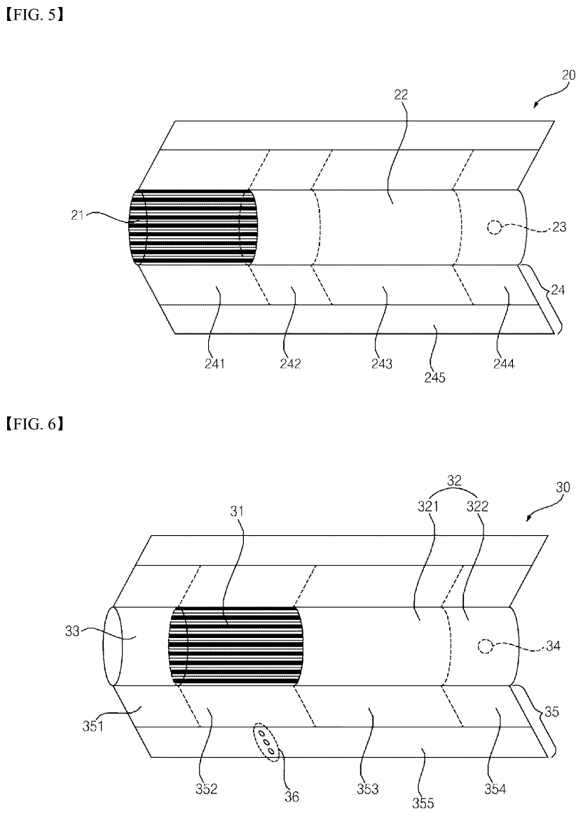

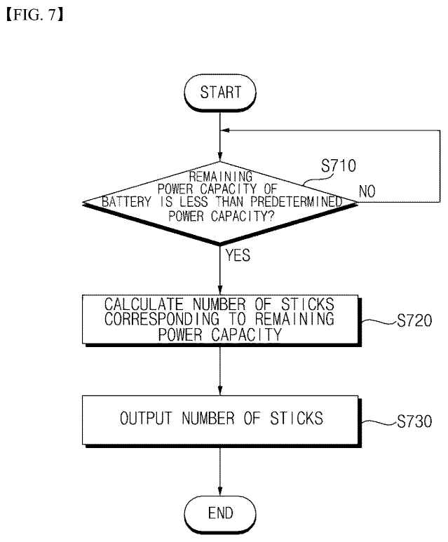

Referring to FIG. 4, the aerosol-generating device 10 according to an embodiment may include a main body 100 supporting the cartridge 200 and a cartridge 200 containing an aerosol-generating substance. The main body 100 may be formed so as to allow the stick 20 to be inserted into an insertion space 1300 therein.

The aerosol-generating device 10 may include a first heater for heating the aerosol-generating substance stored in the cartridge 200. For example, when the user holds one end of the stick 20 in the mouth to inhale the aerosol, the aerosol generated by the first heater may pass through the stick 20. At this time, while the aerosol passes through the stick 20, a flavor may be added to the aerosol. The aerosol containing the flavor may be drawn into the user's oral cavity through one end of the stick 20.

Alternatively, according to another embodiment, the aerosol-generating device 10 may include a first heater for heating the aerosol-generating substance stored in the cartridge 200 and a second heater for heating the stick 20 inserted into the main body 100. For example, the aerosol-generating device 10 may generate an aerosol by heating the aerosol-generating substance stored in the cartridge 200 and the stick 20 using the first heater and the second heater, respectively.

FIGS. 5 and 6 are views for explaining a stick according to embodiments of the present disclosure.

Referring to FIG. 5, the stick 20 may include a tobacco rod 21 and a filter rod 22. The first portion described above with reference to FIG. 2 may include the tobacco rod. The second portion described above with reference to FIG. 2 may include the filter rod 22.

FIG. 5 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

A diameter of the stick 20 may be within a range of 5 mm to 9 mm, and a length of the stick 20 may be about 48 mm, but embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm, but embodiments are not limited thereto.

The stick 20 may be wrapped using at least one wrapper 24. The wrapper 24 may have at least one hole through which external air may be introduced or internal air may be discharged. For example, the stick 20 may be wrapped using one wrapper 24. As another example, the stick 20 may be double-wrapped using at least two wrappers 24. For example, the tobacco rod 21 may be wrapped using a first wrapper 241. For example, the filter rod 22 may be wrapped using wrappers 242, 243, 244. The tobacco rod 21 and the filter rod 22 wrapped by wrappers may be combined. The stick 20 may be re-wrapped by a single wrapper 245. When each of the tobacco rod 21 and the filter rod 22 includes a plurality of segments, each segment may be wrapped using wrappers 242, 243, 244. The entirety of stick 20 composed of a plurality of segments wrapped by wrappers may be re-wrapped by another wrapper

The first wrapper 241 and the second wrapper 242 may be formed of general filter wrapping paper. For example, the first wrapper 241 and the second wrapper 242 may be porous wrapping paper or non-porous wrapping paper. Also, the first wrapper 241 and the second wrapper 242 may be made of an oil-resistant paper sheet and an aluminum laminate packaging material.

The third wrapper 243 may be made of a hard wrapping paper. For example, a basis weight of the third wrapper 243 may be within a range of 88 g/m2 to 96 g/m2. For example, the basis weight of the third wrapper 243 may be within a range of 90 g/m2 to 94 g/m2. Also, a total thickness of the third wrapper 243 may be within a range of 1200 μm to 1300 μm. For example, the total thickness of the third wrapper 243 may be 125 μm.

The fourth wrapper 244 may be made of an oil-resistant hard wrapping paper. For example, a basis weight of the fourth wrapper 244 may be within a range of about 88 g/m2 to about 96 g/m2. For example, the basis weight of the fourth wrapper 244 may be within a range of 90 g/m2 to 94 g/m2. Also, a total thickness of the fourth wrapper 244 may be within a range of 1200 μm to 1300 μm. For example, the total thickness of the fourth wrapper 244 may be 125 μm.

The fifth wrapper 245 may be made of a sterilized paper (MFW). Here, the MFW refers to a paper specially manufactured to have enhanced tensile strength, water resistance, smoothness, and the like, compared to ordinary paper. For example, a basis weight of the fifth wrapper 245 may be within a range of 57 g/m2 to 63 g/m2. For example, a basis weight of the fifth wrapper 245 may be about 60 g/m2. Also, the total thickness of the fifth wrapper 245 may be within a range of 64 μm to 70 μm. For example, the total thickness of the fifth wrapper 245 may be 67 μm.

A predetermined material may be included in the fifth wrapper 245. Here, an example of the predetermined material may be, but is not limited to, silicon. For example, silicon exhibits characteristics like heat resistance with little change due to the temperature, oxidation resistance, resistances to various chemicals, water repellency, electrical insulation, etc. However, any material other than silicon may be applied to (or coated on) the fifth wrapper 245 without limitation as long as the material has the above-mentioned characteristics.

The fifth wrapper 245 may prevent the stick 20 from being burned. For example, when the tobacco rod 21 is heated by the heater 110, there is a possibility that the stick 20 is burned. In detail, when the temperature is raised to a temperature above the ignition point of any one of materials included in the tobacco rod 21, the stick 20 may be burned. Even in this case, since the fifth wrapper 245 include a non-combustible material, the burning of the stick 20 may be prevented.

Furthermore, the fifth wrapper 245 may prevent the aerosol generating device 100 from being contaminated by substances formed by the stick 20. Through puffs of a user, liquid substances may be formed in the stick 20. For example, as the aerosol formed by the stick 20 is cooled by the outside air, liquid materials (e.g., moisture, etc.) may be formed. As the fifth wrapper 245 wraps the stick 20, the liquid materials formed in the stick 20 may be prevented from being leaked out of the stick 20.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may be a cellulous acetate filter. For example, the first segment may be a tube-type structure having a hollow inside. The first segment may prevent an internal material of the tobacco rod 21 from being pushed back when the heater 110 is inserted into the tobacco rod 21 and may also provide a cooling effect to aerosol. A diameter of the hollow included in the first segment may be an appropriate diameter within a range of 2 mm to 4.5 mm but is not limited thereto.

The length of the first segment may be an appropriate length within a range of 4 mm to 30 mm but is not limited thereto. For example, the length of the first segment may be 10 mm but is not limited thereto.

The second segment of the filter rod 22 cools the aerosol which is generated when the heater 110 heats the tobacco rod 21. Therefore, the user may puff the aerosol which is cooled at an appropriate temperature.

The length or diameter of the second segment may be variously determined according to the shape of the stick 20. For example, the length of the second segment may be an appropriate length within a range of 7 mm to 20 mm. Preferably, the length of the second segment may be about 14 mm but is not limited thereto.

The second segment may be manufactured by weaving a polymer fiber. In this case, a flavoring liquid may also be applied to the fiber formed of the polymer. Alternatively, the second segment may be manufactured by weaving together an additional fiber coated with a flavoring liquid and a fiber formed of a polymer. Alternatively, the second segment may be formed by a crimped polymer sheet.

For example, a polymer may be formed of a material selected from the group consisting of polyethylene (PE), polypropylene (PP), polyvinyl chloride (PVC), polyethylene terephthalate (PET), polylactic acid (PLA), cellulous acetate (CA), and aluminum coil.

As the second segment is formed by the woven polymer fiber or the crimped polymer sheet, the second segment may include a single channel or a plurality of channels extending in a longitudinal direction. Here, a channel refers to a passage through which a gas (e.g., air or aerosol) passes.

For example, the second segment formed of the crimped polymer sheet may be formed from a material having a thickness between about 5 μm and about 300 μm, for example, between about 10 μm and about 250 μm. Also, a total surface area of the second segment may be between about 300 mm2/mm and about 1000 mm2/mm. In addition, an aerosol cooling element may be formed from a material having a specific surface area between about 10 mm2/mg and about 100 mm2/mg.

The second segment may include a thread including a volatile flavor component. Here, the volatile flavor component may be menthol but is not limited thereto. For example, the thread may be filled with a sufficient amount of menthol to provide the second segment with menthol of 1.5 mg or more.

The third segment of the filter rod 22 may be a cellulous acetate filter. The length of the third segment may be an appropriate length within a range of 4 mm to 20 mm. For example, the length of the third segment may be about 12 mm but is not limited thereto.

The filter rod 22 may be manufactured to generate flavors. For example, a flavoring liquid may be injected onto the filter rod 22. For example, an additional fiber coated with a flavoring liquid may be inserted into the filter rod 22.

Also, the filter rod 22 may include at least one capsule 23. Here, the capsule 23 may generate a flavor. The capsule 23 may generate an aerosol. For example, the capsule 23 may have a configuration in which a liquid including a flavoring material is wrapped with a film. The capsule 23 may have a spherical or cylindrical shape but is not limited thereto.

Referring to FIG. 6, a stick 30 may further include a front-end plug 33. The front-end plug 33 may be located on a side of a tobacco rod 31, the side not facing a filter rod 32. The front-end plug 33 may prevent the tobacco rod 31 from being detached and prevent liquefied aerosol from flowing into the aerosol generating device 10 from the tobacco rod 31, during smoking.

The filter rod 32 may include a first segment 321 and a second segment 322. The first segment 321 may correspond to the first segment of the filter rod 22 of FIG. 4. The segment 322 may correspond to the third segment of the filter rod 22 of FIG. 4.

A diameter and a total length of the stick 30 may correspond to the diameter and a total length of the stick 20 of FIG. 4. For example, a length of the front-end plug 33 may be about 7 mm, a length of the tobacco rod 31 may be about 15 mm, a length of the first segment 321 may be about 12 mm, and a length of the second segment 322 may be about 14 mm, but embodiments are not limited thereto.

The stick 30 may be wrapped using at least one wrapper 35. The wrapper 35 may have at least one hole through which external air may be introduced or internal air may be discharged.

For example, the front-end plug 33 may be wrapped using a first wrapper 351, the tobacco rod 31 may be wrapped using a second wrapper 352, the first segment 321 may be wrapped using a third wrapper 353, and the second segment 322 may be wrapped using a fourth wrapper 354. Also, the entire stick 30 may be re-wrapped using a fifth wrapper 355.

In addition, the fifth wrapper 355 may have at least one perforation 36 formed therein. For example, the perforation 36 may be formed in an area of the fifth wrapper 355 surrounding the tobacco rod 31 but is not limited thereto. For example, the perforation 36 may transfer heat formed by the heater 210 illustrated in FIG. 3 into the tobacco rod 31.

Also, the second segment 322 may include at least one capsule 34. Here, the capsule 34 may generate a flavor. The capsule 34 may generate an aerosol. For example, the capsule 34 may have a configuration in which a liquid including a flavoring material is wrapped with a film. The capsule 34 may have a spherical or cylindrical shape but is not limited thereto.

The first wrapper 351 may be formed by combining general filter wrapping paper with a metal foil such as an aluminum coil. For example, a total thickness of the first wrapper 351 may be within a range of 45 μm to 55 μm. For example, the total thickness of the first wrapper 351 may be 50.3 μm. Also, a thickness of the metal coil of the first wrapper 351 may be within a range 6 μm to 7 μm. For example, the thickness of the metal coil of the first wrapper 351 may be 6.3 μm. In addition, a basis weight of the first wrapper 351 may be within a range of 50 g/m2 to 55 g/m2. For example, the basis weight of the first wrapper 351 may be 53 g/m2.

The second wrapper 352 and the third wrapper 353 may be formed of general filter wrapping paper. For example, the second wrapper 352 and the third wrapper 353 may be porous wrapping paper or non-porous wrapping paper.

For example, porosity of the second wrapper 352 may be 35000 CU but is not limited thereto. Also, a thickness of the second wrapper 352 may be within a range of 70 μm to 80 μm. For example, the thickness of the second wrapper 352 may be 78 μm. A basis weight of the second wrapper 352 may be within a range of 20 g/m2 to 25 g/m2. For example, the basis weight of the second wrapper 352 may be 23.5 g/m2.

For example, porosity of the third wrapper 353 may be 24000 CU but is not limited thereto. Also, a thickness of the third wrapper 353 may be in a range of about 60 μm to about 70 μm. For example, the thickness of the third wrapper 353 may be 68 μm. A basis weight of the third wrapper 353 may be in a range of about 20 g/m2 to about 25 g/m2. For example, the basis weight of the third wrapper 353 may be 21 g/m2.

The fourth wrapper 354 may be formed of PLA laminated paper. Here, the PLA laminated paper refers to three-layer paper including a paper layer, a PLA layer, and a paper layer. For example, a thickness of the fourth wrapper 353 may be in a range of 100 μm to 1200 μm. For example, the thickness of the fourth wrapper 353 may be 110 μm. Also, a basis weight of the fourth wrapper 354 may be in a range of 80 g/m2 to 100 g/m2. For example, the basis weight of the fourth wrapper 354 may be 88 g/m2.

The fifth wrapper 355 may be formed of sterilized paper (MFW). Here, the sterilized paper (MFW) refers to paper which is particularly manufactured to improve tensile strength, water resistance, smoothness, and the like more than ordinary paper. For example, a basis weight of the fifth wrapper 355 may be in a range of 57 g/m2 to 63 g/m2. For example, the basis weight of the fifth wrapper 355 may be 60 g/m2. Also, a thickness of the fifth wrapper 355 may be in a range of 64 μm to 70 μm. For example, the thickness of the fifth wrapper 355 may be 67 μm.

The fifth wrapper 355 may include a preset material added thereto. An example of the material may include silicon, but it is not limited thereto. Silicon has characteristics such as heat resistance robust to temperature conditions, oxidation resistance, resistance to various chemicals, water repellency to water, and electrical insulation, etc. Besides silicon, any other materials having characteristics as described above may be applied to (or coated on) the fifth wrapper 355 without limitation.

The front-end plug 33 may be formed of cellulous acetate. For example, the front-end plug 33 may be formed by adding a plasticizer (e.g., triacetin) to cellulous acetate tow. Mono-denier of filaments constituting the cellulous acetate tow may be in a range of 1.0 to 10.0. For example, the mono-denier of filaments constituting the cellulous acetate tow may be within a range of 4.0 to 6.0. For example, the mono-denier of the filaments of the front-end plug 33 may be 5.0. Also, a cross-section of the filaments constituting the front-end plug 33 may be a Y shape. Total denier of the front-end plug 33 may be in a range of 20000 to 30000. For example, the total denier of the front-end plug 33 may be within a range of 25000 to 30000. For example, the total denier of the front-end plug 33 may be 28000.

Also, as needed, the front-end plug 33 may include at least one channel. A cross-sectional shape of the channel may be manufactured in various shapes.

The tobacco rod 31 may correspond to the tobacco rod 21 described above with reference to FIG. 4. Therefore, hereinafter, the detailed description of the tobacco rod 31 will be omitted.

The first segment 321 may be formed of cellulous acetate. For example, the first segment 321 may be a tube-type structure having a hollow inside. The first segment 321 may be manufactured by adding a plasticizer (e.g., triacetin) to cellulous acetate tow. For example, mono-denier and total denier of the first segment 321 may be the same as the mono-denier and total denier of the front-end plug 33.

The second segment 322 may be formed of cellulous acetate. Mono denier of filaments constituting the second segment 322 may be in a range of 1.0 to 10.0. For example, the mono denier of the filaments of the second segment 322 may be within a range of about 8.0 to about 10.0. For example, the mono denier of the filaments of the second segment 322 may be 9.0. Also, a cross-section of the filaments of the second segment 322 may be a Y shape. Total denier of the second segment 322 may be in a range of 20000 to 30000. For example, the total denier of the second segment 322 may be 25000.

FIG. 7 is a flowchart illustrating a method of operating an aerosol generating device according to an embodiment of the present disclosure.

Referring to FIG. 7, the aerosol generating device 10 may determine whether a remaining power capacity of the battery 16 is less than a predetermined power capacity in operation S710. Here, the predetermined power capacity may refer to a power capacity set as a reference for informing a user of the remaining power capacity of the battery 16. For example, the predetermined power capacity may be a power capacity corresponding to 30% of the maximum power capacity stored in the battery 16.

When the remaining power capacity of the battery 16 is greater than or equal to the predetermined power capacity, the aerosol generating device 10 may continue to monitor whether the remaining power capacity of the battery 16 is less than the predetermined power capacity. Here, the aerosol generating device 10 may output the remaining power capacity of the battery 16 through a display. For example, the aerosol generating device 10 may output, through the display, a home screen including an indicator that indicates the remaining power capacity of the battery 16.

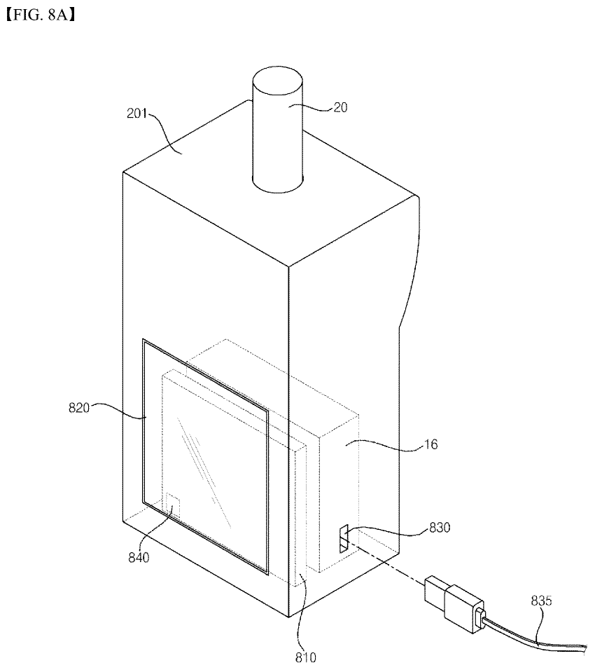

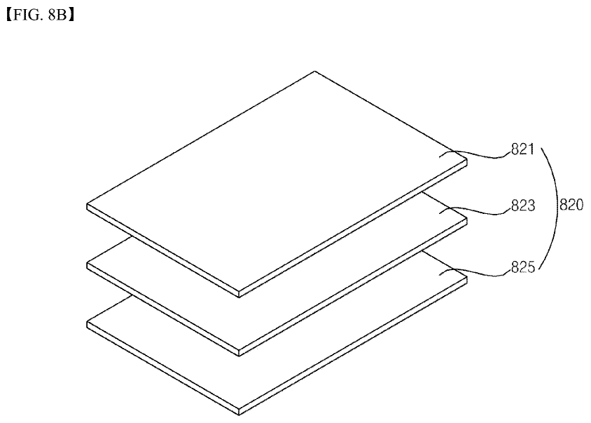

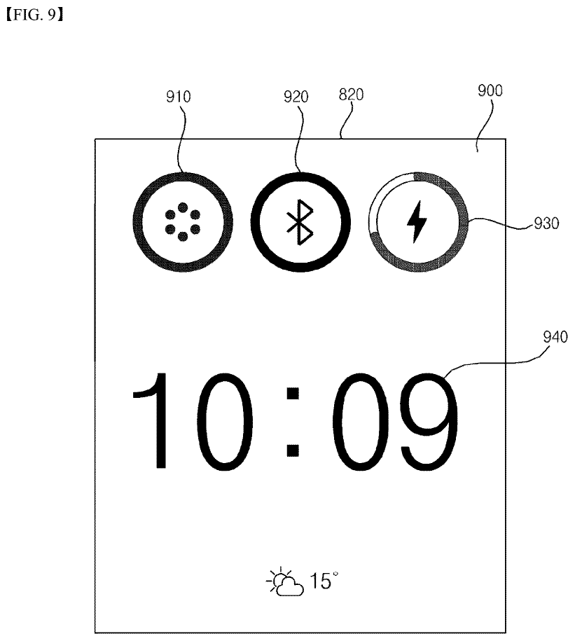

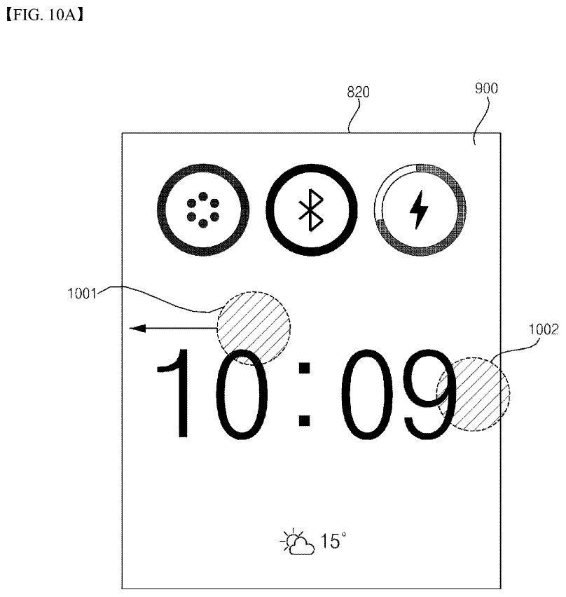

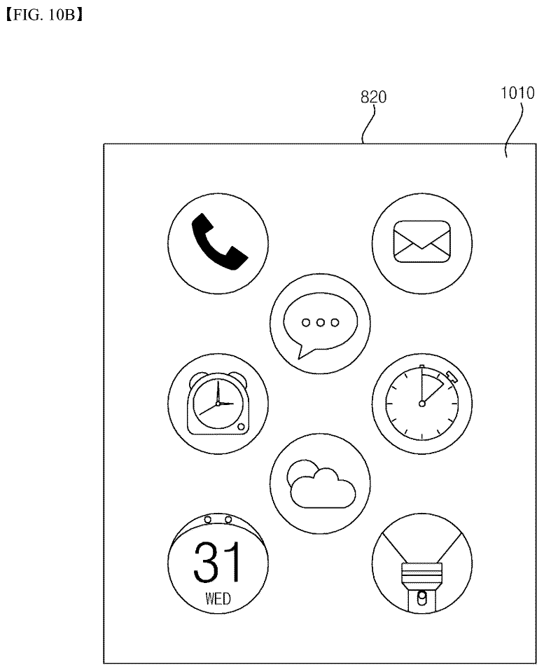

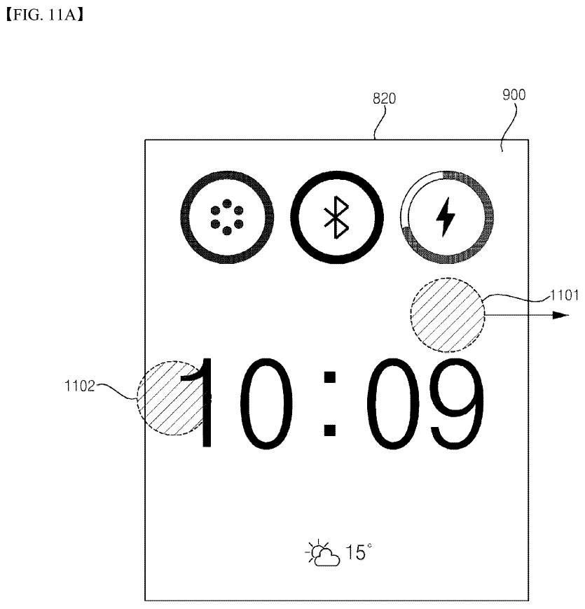

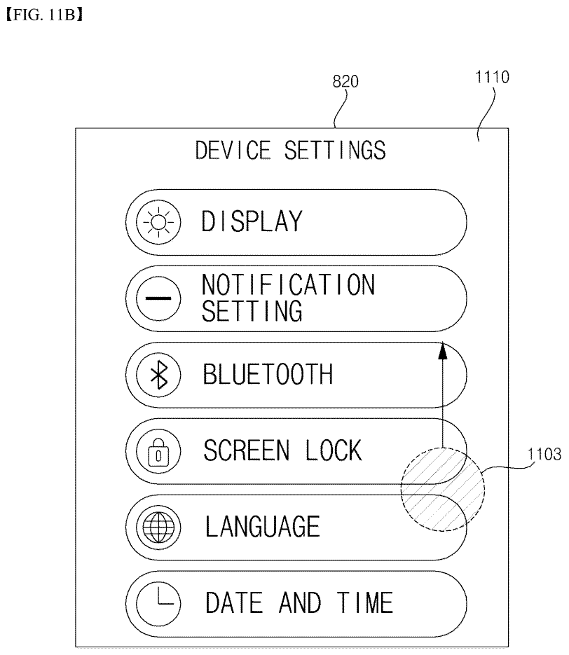

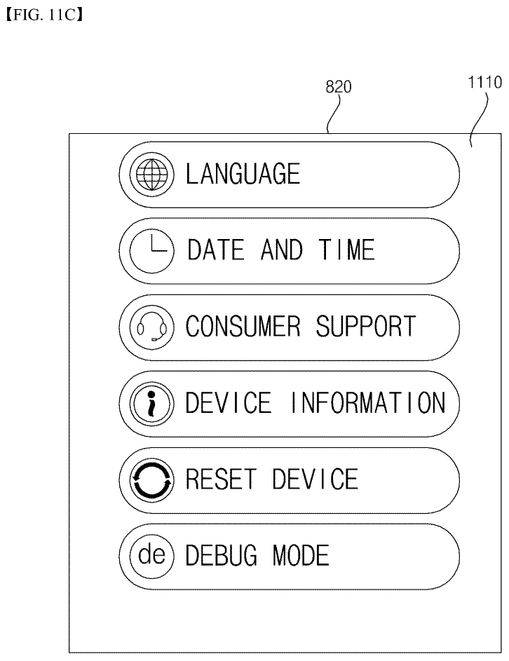

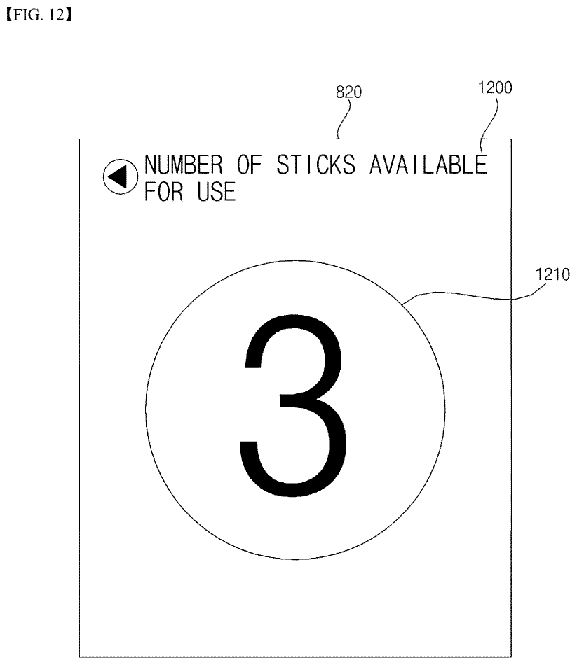

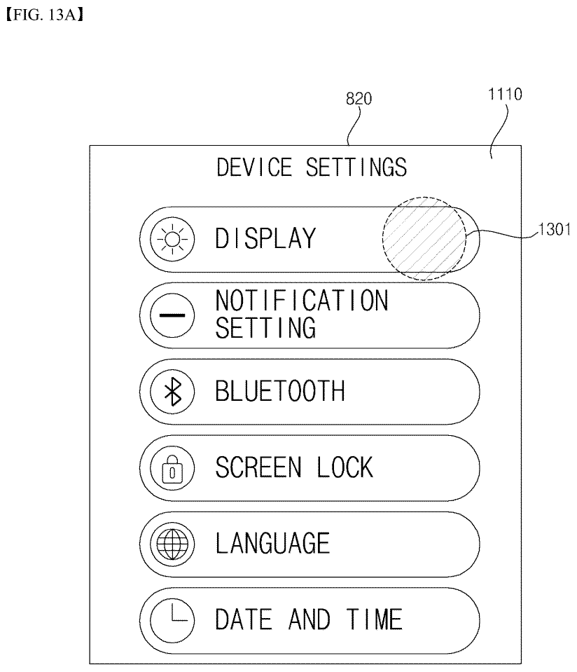

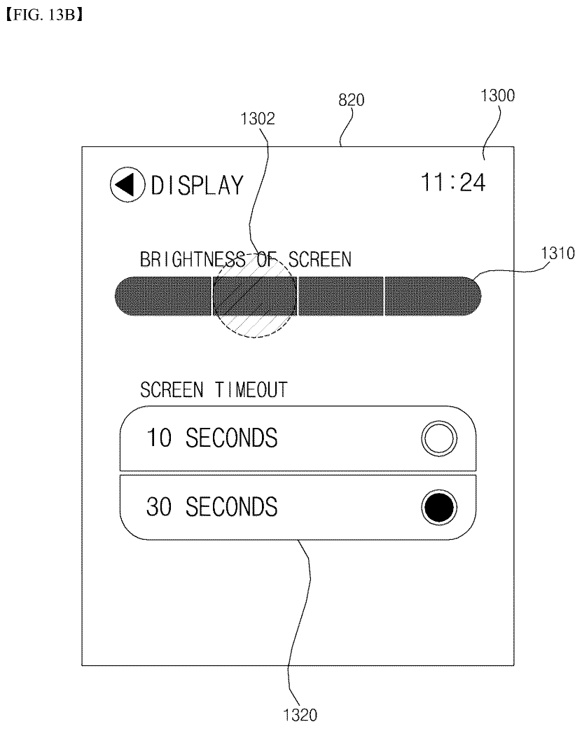

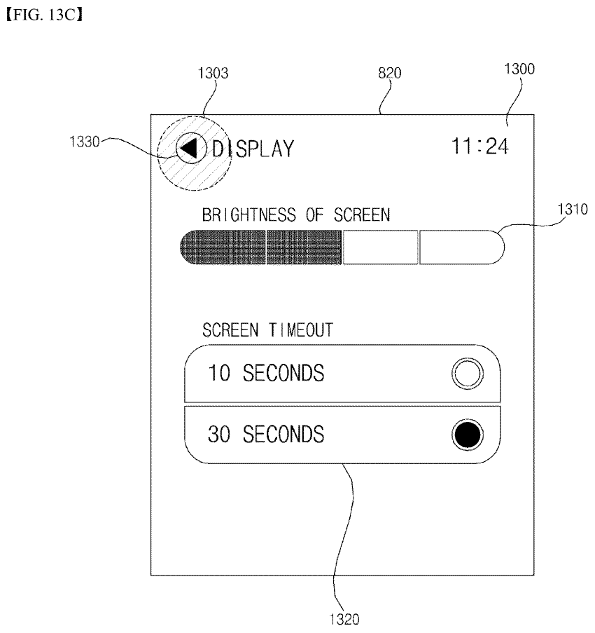

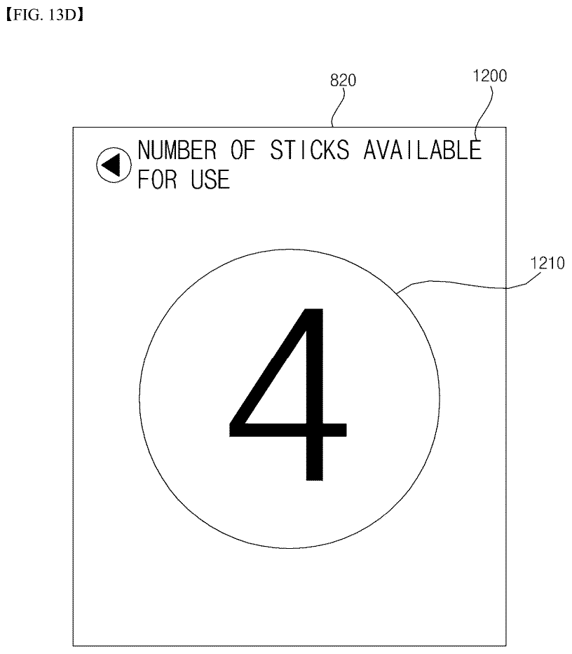

Referring to FIG. 8A, according to an embodiment of the present disclosure, an insertion space into which a cigarette 20 is inserted may be provided at an upper end of a housing 201 of the aerosol generating device 10.

The insertion space may be recessed into the housing 201 by a predetermined depth, so as to allow at least a portion of the cigarette 20 to be inserted therein. The depth of the insertion space may correspond to the length of a section or portion of the cigarette 20 that contains an aerosol generating substance. For example, when the aerosol generating device 10 is a device capable of using the cigarette 20 of FIG. 5, the depth of the insertion space may correspond to the length of the tobacco rod 21 of the cigarette 20.

The battery 16, a printed circuit board 810, a heater, and the like may be disposed in the housing 201 of the aerosol generating device 10.

Each of the components provided at the aerosol generating device 10 may be mounted on one surface and/or another surface of a printed circuit board 810. The components mounted on the printed circuit board 810 may transmit or receive signals to or from each other through a wiring layer of the printed circuit board 810. For example, at least one communication module included in the communication interface 11, at least one sensor included in the sensor module 15, the controller 17, and the like may be mounted on the printed circuit board 810.

The printed circuit board 810 may be disposed adjacent to the battery 16. For example, the printed circuit board 810 may be disposed such that one surface thereof faces the battery 16.

A temperature sensor may be mounted on one surface of the printed circuit board 810. The temperature sensor may be implemented using a thermistor, which is a device whose resistance changes with temperature, or the like. For example, the temperature sensor may include a negative temperature coefficient thermistor (NTC thermistor) whose resistance decreases as temperature increases.

The controller 17 may determine a temperature of the battery 16 based on a value detected by the temperature sensor. For example, the controller 17 may determine the value detected by the temperature sensor as the temperature of the battery 16. For example, the controller 17 may determine a result value, which is obtained by compensating the value detected by the temperature sensor based on a predetermined reference, as the temperature of the battery 16.

A display 820 may be disposed on one side of the housing 201. The display 820 may display a screen based on a signal transmitted from the controller 17.

A power terminal 830 may be disposed on one side of the housing 201 of the aerosol generating device 10. The power terminal 830 may be a wired terminal for wired communication such as USB.

A power supply circuit (not shown) may be disposed between the battery 16 and the power terminal 830. The power supply circuit may transmit power supplied from the outside to the battery 16 through the power terminal 830.

A power line 835 for supplying power may be connected to the power terminal 830. For example, the power terminal 830 may be coupled to a connector of the power line 835.

The controller 17 may determine whether the power line 835 is connected to the power terminal 830. For example, the controller 17 may determine whether the power line 835 is connected to the power terminal 830 based on a signal generated in response to connection between the power terminal 830 and the power line 835.

When the power line 835 is connected to the power terminal 830, the controller 17 may start charging the battery 16. When the power line 835 is connected to the power terminal 830, the controller 17 may control the operation of each of the components provided at the aerosol generating device 10, so that power supplied through the power line 835 is transmitted to the battery 16. For example, when the power line 835 is connected to the power terminal 830 while the cigarette 20 is inserted into the housing 201, the controller 17 may cut off the supply of power to the aerosol generating module 130, and may start charging of the battery 16.

At least one motor 840 that produces vibration to generate a haptic effect may be disposed in the housing 101. The motor 840 may be mounted on another surface of the printed circuit board 810. For example, the motor 840 may be implemented as a linear actuator or the like, but is not limited thereto.

The structure of the aerosol generating device 10 is not limited to that shown in FIG. 8A, and the arrangement of the battery 16, the printed circuit board 810, the display 820, the power terminal 830, and the motor 840 may vary according to an embodiment.

Referring to FIG. 8B, the display 820 may include a cover glass 821, a display panel 823, and/or a touch panel 825.

The cover glass 821, together with the housing 201, may define an outer appearance of the aerosol generating device 10. The cover glass 821 may come into contact with a part of the body of a user. The cover glass 821 may protect the display panel 823 and/or the touch panel 825 from external impact.

The display panel 823 may be disposed in a direction from the cover glass 821 toward an inside of the housing 201. For example, the display panel 823 may be disposed parallel to the cover glass 821.

The display panel 823 may output an image. The display panel 823 may output an image based on a signal transmitted from the controller 17. For example, the display panel 823 may be implemented as a liquid crystal display (LCD) panel, an organic light emitting diode (OLED) panel, or the like, but is not limited thereto.

The touch panel 825 may be disposed in a direction from the cover glass 821 toward the inside of the housing 201. For example, the touch panel 825 may be disposed parallel to the cover glass 821 and the display panel 823.

The touch panel 825 may detect a touch corresponding to contact of an object. For example, the touch panel 825 may detect a touch corresponding to a touch of a part of the body of the user.

The touch panel 825 may include at least one touch sensor for sensing or detecting a touch. Examples of the touch sensor may include a capacitive touch sensor, a resistive touch sensor, a surface acoustic wave touch sensor, and an infrared touch sensor, but are not limited thereto.

A plurality of touch sensors included in the touch panel 825 may receive a driving signal according to a predetermined period. For example, the plurality of touch sensors included in the touch panel 825 may receive a driving signal according to a predetermined period. Based on the driving signal, the plurality of touch sensors may each output an electrical signal corresponding to a state (e.g., pressure, magnetic field, capacitance, and quantity of light).

The controller 17 may determine whether a touch input is received by monitoring a signal output from the touch panel 825. The controller 17 may perform a determination on a touch input based on the signal output from the touch panel 825. For example, the controller 17 may perform a determination on coordinates of a touch input, a touch area (or region), single touch, multi-touch, the intensity of a touch, and the like. For example, the controller 17 may perform a determination on a long touch input, which is a touch detected for a predetermined time or longer, a short touch input, which is a touch detected for less than the predetermined time, and a swiping (or swipe) touch input in which the position of a touch input is continuously changed in a specific direction.

Meanwhile, the display panel 823 and the touch panel 825 may be configured as one panel. For example, the touch panel 825 may be inserted into the display panel 823 (on-cell type or in-cell type). For example, the touch panel 825 may be added on the display panel 823 (add-on type).

Referring to FIG. 9, the aerosol generating device 10 may output a home screen 900 through the display 820. For example, when the display 820 is turned on from an OFF state, the home screen 900 may be displayed through the display 820.

The home screen 900 may include at least one indicator. For example, the home screen 900 may include an indicator 910 that indicates an operating state of the aerosol generating device 10, an indicator 920 that indicates a communication state, an indicator 930 that indicates a remaining power capacity of the battery 16, and an indicator 940 that indicates a current time. Meanwhile, in a state where a screen is displayed through the display 820, the aerosol generating device 10 may change the screen displayed through the display 820 in response to a touch input on the display 820.

Referring to FIGS. 10A and 10B, when a swiping touch input 1001 toward the left (or in a left direction) is received while the home screen 900 is displayed on the display 820, the aerosol generating device 10 may switch the home screen 900 displayed through the display 820 to an application screen 1010.

In one embodiment, when a short touch input 1002 that touches a right edge area of the home screen 900 is received while the home screen 900 is displayed, the aerosol generating device 10 may switch the home screen 900 displayed through the display 820 to the application screen 1010.

The application screen 1010 may include at least one object corresponding to applications installed in the aerosol generating device 10. In this case, when the user touches and selects any one of the objects included in the application screen 1010, the aerosol generating device 10 may execute an application corresponding to the selected object.

Meanwhile, referring to FIGS. 11A to 11C, when a swiping touch input 1101 toward the right (or in a right direction) is received while the home screen 900 is displayed, the aerosol generating device 10 may switch the home screen 900 displayed through the display 820 to a setting screen 1110.

In one embodiment, when a short touch input 1102 that touches a left edge area of the home screen 900 is received while the home screen 900 is displayed, the aerosol generating device 10 may switch the home screen 900 displayed through the display 820 to the setting screen 1110.

The setting screen 1110 may include at least one object (hereinafter referred to as a “setting object”) corresponding to setting items related to the operation, function, state of the aerosol generating device 10.

Meanwhile, when there is a plurality of setting objects, the plurality of setting objects may not be all included in the screen displayed through the display 820. In this case, when a swiping touch input 1103 toward the top (or in an up direction) is received while the setting screen 1110 is displayed, the aerosol generating device 10 may change setting objects included in the setting screen 1110 according to the order of the setting objects.

Referring back to FIG. 7, when the remaining power capacity of the battery 16 is less than the predetermined power capacity, the aerosol generating device 10 may calculate the number of sticks 20 corresponding to the remaining power capacity of the battery 16 in operation S720.

In one embodiment, the aerosol generating device 10 may calculate the number of sticks 20 corresponding to the remaining power capacity of the battery 16 based on the amount of power supplied to the heater and the amount of power supplied to the components except the heater.

Here, the amount of power supplied to the heater may correspond to the amount of power supplied to the heater while the user uses or vapes one stick 20 according to a predetermined number of puffs (e.g., 14 times). The amount of power supplied to the components except the heater may correspond to the amount of power supplied to components such as the display 820 based on currently set setting items while the user uses or vapes one stick 20 according to a predetermined number of puffs (e.g., 14 times).

Meanwhile, when there is a change in the setting items related to the operation, function, and state of the aerosol generating device 10, the amount of power supplied to the heater and/or the amount of power supplied to the components except the heater may be changed. For example, when a setting related to the amount of atomization is changed, the aerosol generating device 10 may change the amount of power supplied to the heater. For example, when a setting related to the output of the display 820 is changed, the aerosol generating device 10 may change the amount of power supplied to the components except the heater.

The aerosol generating device 10 may output, through the display 820, the number of sticks 20 corresponding to the remaining power capacity of the battery 16 in operation S730. For example, when the display 820 is in an OFF state, the aerosol generating device 10 may turn on the display 920 to output the number of sticks 20 corresponding to the remaining power capacity of the battery 16.

Referring to FIG. 12, the aerosol generating device 10 may output, through the display 820, a notification screen 1200 showing the number of sticks 20 corresponding to the remaining power capacity of the battery 16.

The notification screen 1200 may include an object 1210 corresponding to the number of sticks 20 available for the user to use based on the remaining power capacity of the battery 16.

Referring to FIGS. 13A to 13D, when a short touch input 1301 that touches a setting object corresponding to the display 820 is received while the setting screen 1110 is displayed, the aerosol generating device 10 may output, through the display 820, a first screen 1300 for determining settings related to the display 820.

The first screen 1300 may include a user interface for changing settings related to the display 820. For example, the first screen 1300 may include an object 1310 corresponding to brightness of the display 820, an object 1320 corresponding to an output time of the display 820 (i.e., a screen timeout), and the like.

When a short touch input 1302 that touches the object 1310 corresponding to brightness of the display 820 is received while the first screen 1300 is displayed, the aerosol generating device 10 may determine a brightness value corresponding to a position of the short touch input 1302.

Based on the brightness value corresponding to the position of the short touch input 1302, the aerosol generating device 10 may change the amount of power supplied to the components except the heater. For example, when the brightness value of the display 820 decreases in response to the short touch input 1302, the amount of power supplied to the components other than the heater may decrease. As the amount of power supplied to the components except the heater decreases, the number of sticks 20 corresponding to the remaining power capacity of the battery 16 may increase.

When a short touch input 1303 that touches an object 1330 for ending the display of the first screen 1300 while the first screen 1300 is displayed, the aerosol generating device 10 may change the screen output through the display 820.

In this case, when the number of sticks 20 corresponding to the remaining power capacity of the battery 16 is changed due to a change in the setting item of the aerosol generating device 10, the aerosol generating device 10 may output the notification screen 1200 again through the display 820. For example, when the number of sticks 20 corresponding to the remaining power capacity of the battery 16 is changed due to a decrease in the brightness value of the display 820, the aerosol generating device 10 may switch the screen displayed through the display 820 from the first screen 1300 to the notification screen 1200.

Meanwhile, when the number of sticks 20 corresponding to the remaining power capacity of the battery 16 remains unchanged even after changing the setting item of the aerosol generating device 10, the aerosol generating device 10 may switch the screen displayed through the display 820 from the first screen 1300 to the setting screen 1110.

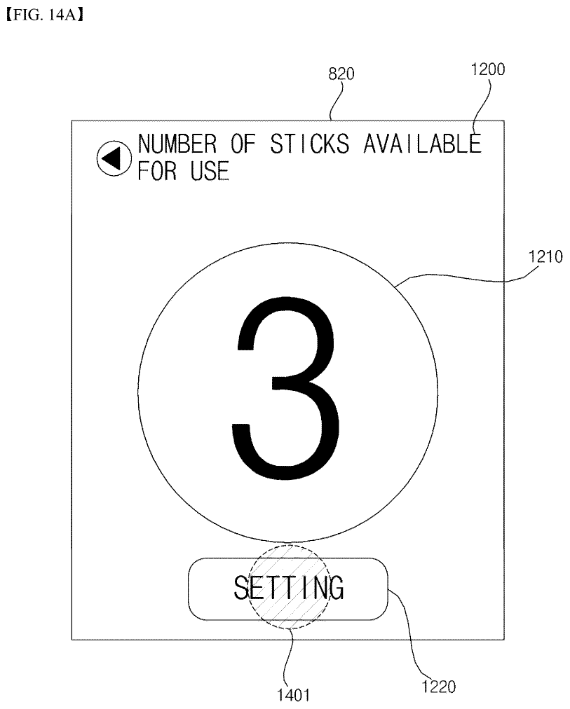

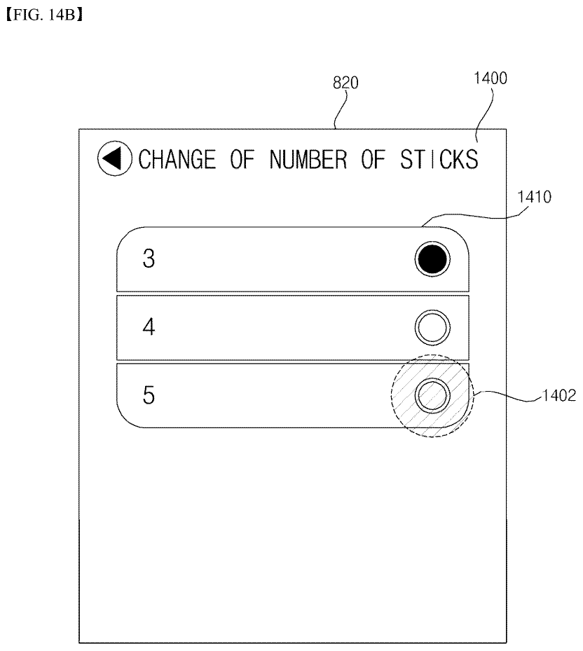

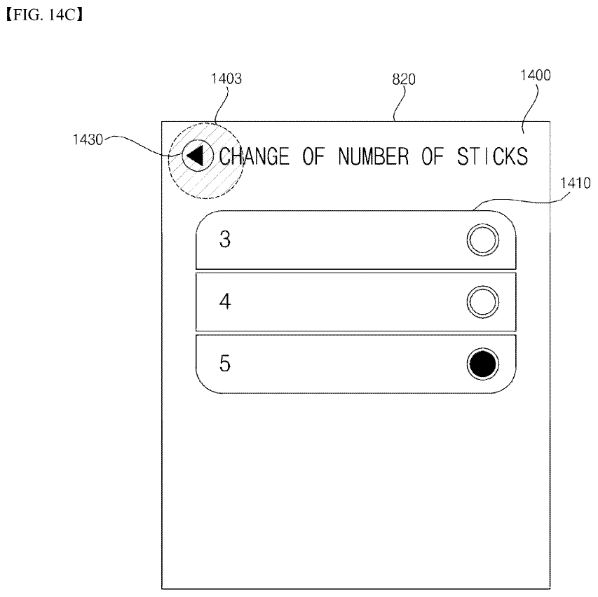

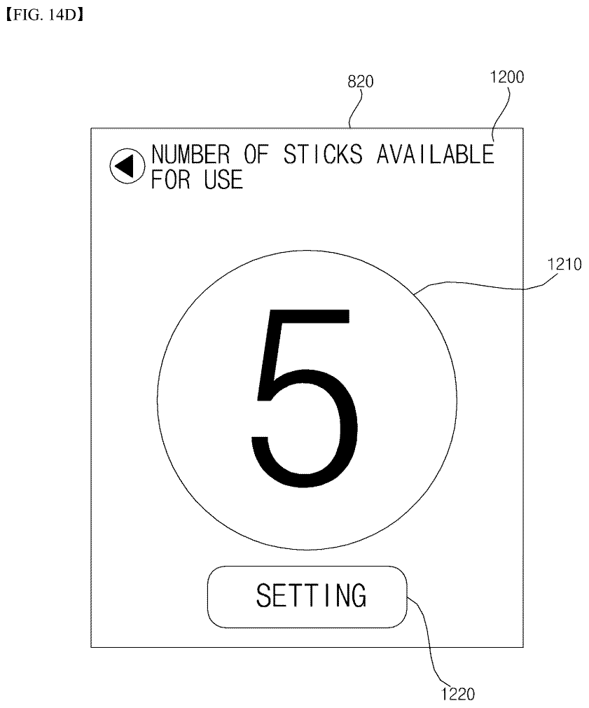

Referring to FIGS. 14A to 14D, the notification screen 1200 may further include an object 1220 related to a change of the number of sticks 20 corresponding to the remaining power capacity of the battery 16.

When a short touch input 1401 that touches the object 1220 related to a change of the number of sticks 20 corresponding to the remaining power capacity of the battery 16 is received while the notification screen 1200 is displayed, the aerosol generating device 10 may output, through the display 820, a second screen 1400 for changing the number of sticks 20 corresponding to the remaining power capacity of the battery 16.

The second screen 1400 may include a user interface for changing the number of sticks 20 corresponding to the remaining power capacity of the battery 16. For example, the second screen 1400 may include at least one object 1410 corresponding to the number of sticks 20.

In this case, a permissible range of change in the number of the sticks 20 may be determined based on the degree or extent to which the amount of power supplied to the components except the heater is changed due to a change in setting item of the aerosol generating device 10.

When a short touch input 1402 that touches any one of sections of the object 1410 corresponding to the number of sticks 20 is received while the second screen 1400 is displayed, the aerosol generating device 10 may determine the number of sticks 20 corresponding to a position of the short touch input 1402.

Based on the number of sticks 20 corresponding to the position of the short touch input 1402, the aerosol generating device 10 may change the amount of power supplied to the components except the heater. For example, when the number of sticks 20 increases in response to the short touch input 1402, the amount of power supplied to the components other than the heater may decrease. As the amount of power supplied to the components except the heater decreases, a brightness value and/or output time of the display 820 may decrease.

When a short touch input 1403 that touches an object 1430 for ending the display of the second screen 1400 is received while the second screen 1400 is displayed, the aerosol generating device 10 may switch the screen output through the display 820 to the notification screen 1200.

As described above, according to at least one of the embodiments of the present disclosure, a screen displayed on the display 820 may be intuitively switched.

According to at least one of the embodiments of the present disclosure, information regarding the remaining power capacity of the battery 16 may be provided to a user in various ways.

According to at least one of the embodiments of the present disclosure, the number of sticks available for use based on the remaining power capacity of the battery 16 may be informed to a user.

According to at least one of the embodiments of the present disclosure, settings related to power consumption may be variously changed so as to allow a user to consume a desired number of sticks.

Referring to FIGS. 1 to 14D, an aerosol generating device 10 according to one aspect of the present disclosure may include: a housing 201 having an insertion space into which a stick 20 is inserted; a battery 16; a display 820; and a controller 17. The controller 17 may be configured to: calculate, based on a remaining power capacity stored in the battery 16 being less than a predetermined power capacity, a number of sticks 20 corresponding to the remaining power capacity; and output the calculated number of sticks 20 through the display 820.

According to another aspect of the present disclosure, the controller 17 may be configured to, based on a setting related to use of power stored in the battery 16 being changed, recalculate a number of sticks 20 corresponding to the remaining power capacity according to the changed setting.

According to another aspect of the present disclosure, the controller 17 may be configured to, based on at least one of brightness of a screen displayed on the display 820 and a display time of the screen being changed, recalculate a number of sticks 20 corresponding to the remaining power capacity.

According to another aspect of the present disclosure, the aerosol generating device 10 may further include an input device 825 configured to receive a user input. The controller 17 may be configured to: output, through the display 820, a user interface related to changing the number of sticks 20; and change, in response to receiving an input of changing the number of sticks 20 through the input device 825, a setting related to an output of the display 820.

According to another aspect of the present disclosure, the controller 17 may be configured to, based on a decrease in number of sticks 20 corresponding to the remaining power capacity, output the decreased number of sticks 20 through the display 820.

According to another aspect of the present disclosure, the controller 17 may be configured to, based on the remaining power capacity and an amount of power consumed while using one stick 20, calculate the number of sticks 20 corresponding to the remaining power capacity.

A method of operating an aerosol generating device 10 according to one aspect of the present disclosure may include: calculating, based on a remaining power capacity stored in a battery 16 of the aerosol generating device 10 being less than a predetermined power capacity, a number of sticks 20 corresponding to the remaining power capacity; and outputting, through a display 820 of the aerosol generating device 10, the calculated number of sticks 20.

According to another aspect of the present disclosure, the method may further include recalculating, based on a setting related to use of power stored in the battery 16 being changed, a number of sticks 20 corresponding to the remaining power capacity according to the changed setting.

According to another aspect of the present disclosure, the method may further include recalculating, based on at least one of brightness of a screen displayed on the display 820 and a display time of the screen being changed, a number of sticks 20 corresponding to the remaining power capacity.

According to another aspect of the present disclosure, the method may further include:

outputting, through the display 820, a user interface related to changing the number of sticks 20; and changing, in response to receiving an input of changing the number of sticks 20 through an input device 825 of the aerosol generating device 10, a setting related to an output of the display 820.

According to another aspect of the present disclosure, the method may further include outputting, based on a decrease in number of sticks 20 corresponding to the remaining power capacity, the decreased number of sticks 20 through the display 820.

According to another aspect of the present disclosure, the calculating of the number of sticks 20 corresponding to the remaining power capacity may include calculating the number of sticks 20 corresponding to the remaining power capacity based on the remaining power capacity and an amount of power consumed while using one stick 20.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol generating device comprising:
a housing comprising an insertion space configured to accommodate insertion of an aerosol generating stick therein;
a battery;
a display; and
a controller configured to:
calculate, based on a remaining power capacity of the battery being less than a predetermined power capacity, a number of sticks corresponding to the remaining power capacity; and
output the calculated number of sticks through the display.

2. The aerosol generating device of claim 1, wherein the controller is further configured to recalculate a number of sticks corresponding to the remaining power capacity based on a change of a setting related to battery power usage of the aerosol generating device.

3. The aerosol generating device of claim 1, wherein the controller is further configured to recalculate the number of sticks corresponding to the remaining power capacity based on at least one of a brightness setting of the display or a display time setting being changed.

4. The aerosol generating device of claim 1, further comprising an input device configured to receive a user input,
wherein the controller is further configured to:
output, through the display, a user interface for changing the number of sticks; and
change a setting related to an output of the display in response to receiving, through the input device, an input changing the number of sticks.

5. The aerosol generating device of claim 1, wherein the controller is further configured to output a changed number of sticks through the display in response to a change in the number of sticks corresponding to the remaining power capacity.

6. The aerosol generating device of claim 1, wherein the number of sticks corresponding to the remaining power capacity is calculated based on the remaining power capacity and an amount of power consumed while using one stick.

7. A method of operating an aerosol generating device configured to receive an aerosol generating stick therein, the method comprising:
calculating, based on a remaining power capacity of a battery of the aerosol generating device being less than a predetermined power capacity, a number of sticks corresponding to the remaining power capacity; and
outputting, through a display of the aerosol generating device, the calculated number of sticks.

8. The method of claim 7, further comprising recalculating the number of sticks corresponding to the remaining power capacity based on a change of a setting related to battery power usage of the aerosol generating device.

9. The method of claim 7, further comprising recalculating the number of sticks corresponding to the remaining power capacity based on at least one of a brightness setting of the display or a display time setting being changed.

10. The method of claim 7, further comprising:
outputting, through the display, a user interface for changing the number of sticks; and
changing a setting related to an output of the display in response to receiving, through an input device of the aerosol generating device, an input changing the number of sticks.

11. The method of claim 7, further comprising outputting a changed number of sticks through the display in response to a change in the number of sticks corresponding to the remaining power capacity.

12. The method of claim 7, wherein the number of sticks corresponding to the remaining power capacity is calculated based on the remaining power capacity and an amount of power consumed while using one stick.
